(19) United States
(12) Patent Application Publication
(10) Pub. No.: US 2025/0252071 A1
(43) Pub. Date: Aug. 7, 2025

(54) ELECTRONIC SYSTEM AND OPERATING METHOD FOR ELECTRONIC SYSTEM

(71) Applicant: PEGATRON CORPORATION, TAIPEI CITY (TW)

(72) Inventors: Cong-Feng Wei, Taipei City (TW); Wei-Ming Chen, Taipei City (TW); Yu-Shu Yeh, Taipei City (TW)

(73) Assignee: PEGATRON CORPORATION, TAIPEI CITY (TW)

(21) Appl. No.: 18/897,163

(22) Filed: Sep. 26, 2024

(30) Foreign Application Priority Data
Feb. 2, 2024 (TW) 113104087

(51) Int. Cl. G06F 13/40

(52) U.S. Cl. CPC G06F 13/4022; G06F 13/4068; G06F 2213/0016

(57) ABSTRACT

An electronic system and an operating method for the electronic system are provided. The electronic system includes a programmable circuit, a memory circuit, a controller, and a switching circuit. The controller provides a first control signal. The switching circuit has a control terminal, a first terminal, a second terminal, and a third terminal. The first terminal is coupled to the programmable circuit. The second terminal is coupled to the memory circuit. The control terminal and the third terminal are coupled to the controller. The switching circuit receives the first control signal through the control terminal to connect the third terminal to the second terminal, so that update data is stored into the memory circuit.

### CROSS-REFERENCE TO RELATED APPLICATION

This application claims the priority benefit of Taiwan application serial no. 113104087, filed on Feb. 2, 2024. The entirety of the above-mentioned patent application is hereby incorporated by reference herein and made a part of this specification.

### BACKGROUND

### Technical Field

The disclosure relates to an electronic system and an operating method for the electronic system.

### Description of Related Art

An electronic system may include a controller and a field programmable gate array (FPGA). The controller may perform a firmware update to the FPGA using a transmission method that complies with the Joint Test Action Group (JTAG) specifications.

However, the transmission method that complies with the JTAG specifications has limitations on transmission distance. Generally speaking, the effective transmission distance of the above transmission method is about 1 meter. In other words, when the distance between the controller and the FPGA is long, the controller may not use the above transmission method to perform a firmware update to the FPGA.

### SUMMARY

The disclosure provides an electronic system and an operating method for the electronic system, which may perform a remote update operation on a programmable circuit of the electronic system.

The electronic system of the disclosure includes a programmable circuit, a memory circuit, a controller, and a switching circuit. The controller provides a first control signal. The switching circuit has a control terminal, a first terminal, a second terminal, and a third terminal. The first terminal is coupled to the programmable circuit. The second terminal is coupled to the memory circuit. The control terminal and the third terminal are coupled to the controller. The switching circuit receives the first control signal through the control terminal to connect the third terminal to the second terminal, so that update data is stored into the memory circuit.

An operating method of the disclosure is used in an electronic system. The electronic system includes a programmable circuit, a memory circuit, a switching circuit, and a controller. The switching circuit has a control terminal, a first terminal, a second terminal, and a third terminal. The first terminal is coupled to the programmable circuit. The second terminal is coupled to the memory circuit. The control terminal and the third terminal are coupled to the controller. The operating method includes the following steps. A first control signal is provided by the controller. The first control signal is received through the control terminal to connect the third terminal to the second terminal by the switching circuit. Update data is stored from the third terminal into the memory circuit by the controller.

Based on the above, the switching circuit receives the update data and writes the update data to the memory circuit. This disclosure does not require the controller to perform an update to the programmable circuit using the transmission method specified by the Joint Test Action Group (JTAG). Therefore, the update operation of the disclosure does not have limitations on transmission distance.

### BRIEF DESCRIPTION OF THE DRAWINGS

FIG. 1 is a schematic diagram of an electronic system according to an embodiment of the disclosure.

FIG. 2 is a flowchart of an operating method according to an embodiment of the disclosure.

FIG. 3 is a schematic diagram of an electronic system according to an embodiment of the disclosure.

FIG. 4 is a flowchart of an operating method according to an embodiment of the disclosure.

### DESCRIPTION OF THE EMBODIMENTS

Some embodiments of the disclosure will be described in detail below with reference to the accompanying drawings. For reference symbols used in the following descriptions, the same reference symbols in different drawings represent the same or similar components. These embodiments are merely a part of the disclosure, and do not disclose all possible implementations of the disclosure. Rather, these embodiments are merely examples within the scope of the patent application of the disclosure.

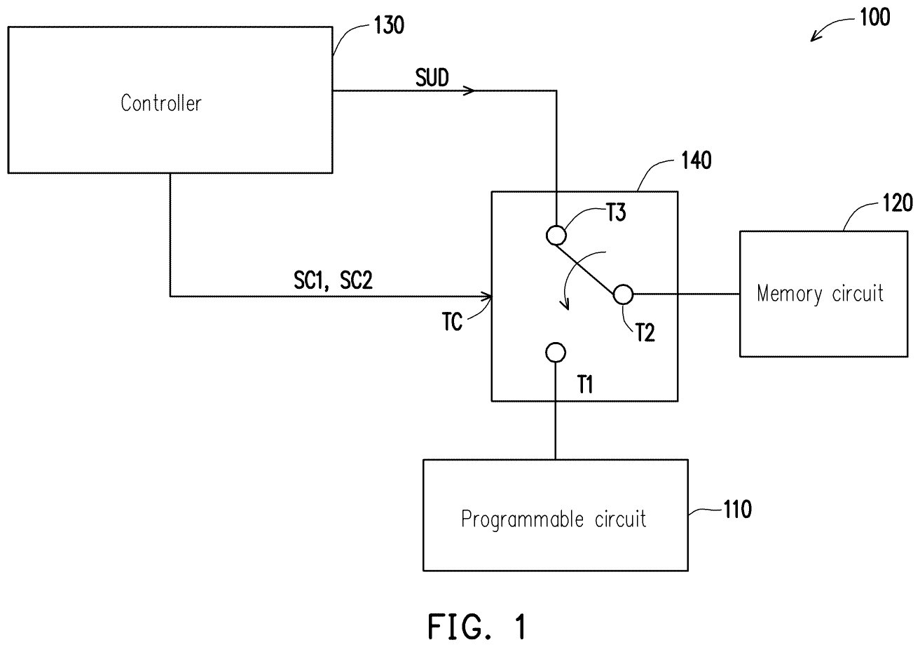

Referring to FIG. 1, FIG. 1 is a schematic diagram of an electronic system according to an embodiment of the disclosure. In the embodiment, an electronic system 100 includes a programmable circuit 110, a memory circuit 120, a controller 130, and a switching circuit 140. For example, the electronic system 100 may be a server rack including a plurality of servers or a facility including server racks, but the disclosure is not limited thereto. For example, the programmable circuit 110 may be, for example, a field programmable gate array (FPGA) or may be used to perform boot settings of at least one server in the server rack, but the disclosure is not limited thereto.

In the embodiment, the switching circuit 140 includes a control terminal TC, a first terminal T1, a second terminal T2, and a third terminal T3. The first terminal T1 is coupled to the programmable circuit 110. The second terminal T2 is coupled to the memory circuit 120. The control terminal TC and the third terminal T3 are coupled to the controller 130.

In the embodiment, the controller 130 controls the connection status between the first terminal T1, the second terminal T2, and the third terminal T3 of the switching circuit 140. The controller 130 provides a first control signal SC1. The switching circuit 140 receives the first control signal SC1 through the control terminal TC. The switching circuit 140 receives update data SUD through the third terminal T3. The switching circuit 140 connects the third terminal T3 to the second terminal T2 based on the first control signal SC1. Therefore, the update data SUD received by the switching circuit 140 is recorded into the memory circuit 120 through the third terminal T3.

In the embodiment, the controller 130 provides a second control signal SC2 based on the memory circuit 120 having stored the update data SUD. The switching circuit 140 receives the second control signal SC2 through the control terminal TC to connect the second terminal T2 to the first terminal T1. Therefore, the update data SUD stored in the memory circuit 120 is loaded into the programmable circuit 110. Therefore, the programmable circuit 110 may use the update data SUD stored in the memory circuit 120 to perform an update operation.

It is worth mentioning here that the switching circuit 140 receives the update data SUD through the third terminal T3 and writes the update data SUD to the memory circuit 120. The controller 130 is connected to the memory circuit 120 through the switching circuit 140, not through the programmable circuit 110 with the Joint Test Action Group (JTAG). That is to say, the update data SUD is transmitted to the memory circuit 120 via the switching circuit 140, not the programmable circuit 110. The programmable circuit 110 does not need to receive the update data SUD and to record the update data SUD into the memory circuit 120 using the transmission method specified by the JTAG. Therefore, the update operation performed by the controller 130 on the programmable circuit 110 does not have limitations on transmission distance.

In the embodiment, the controller 130 provides the second control signal SC2. The control terminal TC of the switching circuit 140 receives the second control signal SC2. The switching circuit 140 connects the second terminal T2 to the first terminal T1 based on the second control signal SC2. Therefore, the programmable circuit 110 is connected to the memory circuit 120 through the switching circuit 140. Therefore, the update data SUD stored in the memory circuit 120 is loaded into the programmable circuit 110.

In the embodiment, the update data SUD may be provided by the controller 130. In some embodiments, the update data SUD may be provided by other circuits.

In the embodiment, the timing when the controller 130 provides the first control signal SC1 may be when the update data SUD is about to be loaded. For example, during the operation of the plurality of servers in the server rack, the switching circuit 140 writes the received update data SUD to the memory circuit 120. The timing when the controller 130 provides the second control signal SC2 may be the timing when the update data SUD has been stored into the memory circuit 120 and the period during the programmable circuit 110 to be updated. For example, the timing when the controller 130 provides the second control signal SC2 may be during the period when the plurality of servers in the server rack are powered on. During the power on of the plurality of servers in the server rack, the programmable circuit 110 uses the update data SUD stored in the memory circuit 120 to perform an update operation.

In the embodiment, the memory circuit 120 may include an electrically-erasable programmable read-only memory (EEPROM) or other storage devices well known to those skilled in the art.

In the embodiment, the controller 130 may include, for example, a board management controller (BMC) for monitoring at least one server rack in the facility.

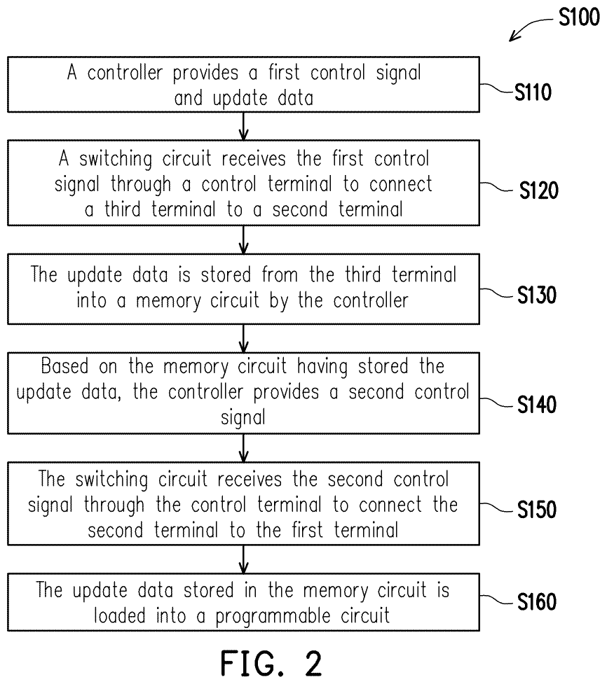

Referring to FIG. 1 and FIG. 2 at the same time, FIG. 2 is a flowchart of an operating method according to an embodiment of the disclosure. In the embodiment, the operating method S100 is applicable to the electronic system 100. The operating method S100 includes steps S110 to S160. In step S110, the controller 130 provides the first control signal SC1. In step S120, the switching circuit 140 receives the first control signal SC1 through the control terminal TC to connect the third terminal T3 to the second terminal T2. In step S130, the update data SUD is stored from the third terminal T3 into the memory circuit 120 by the controller 130. In step S140, based on the memory circuit 120 having stored the update data, the controller 130 provides the second control signal SC2. In step S150, the switching circuit 140 receives the second control signal SC2 through the control terminal TC to connect the second terminal T2 to the first terminal T1. In step S160, the update data SUD stored in the memory circuit 120 is loaded into the programmable circuit 110.

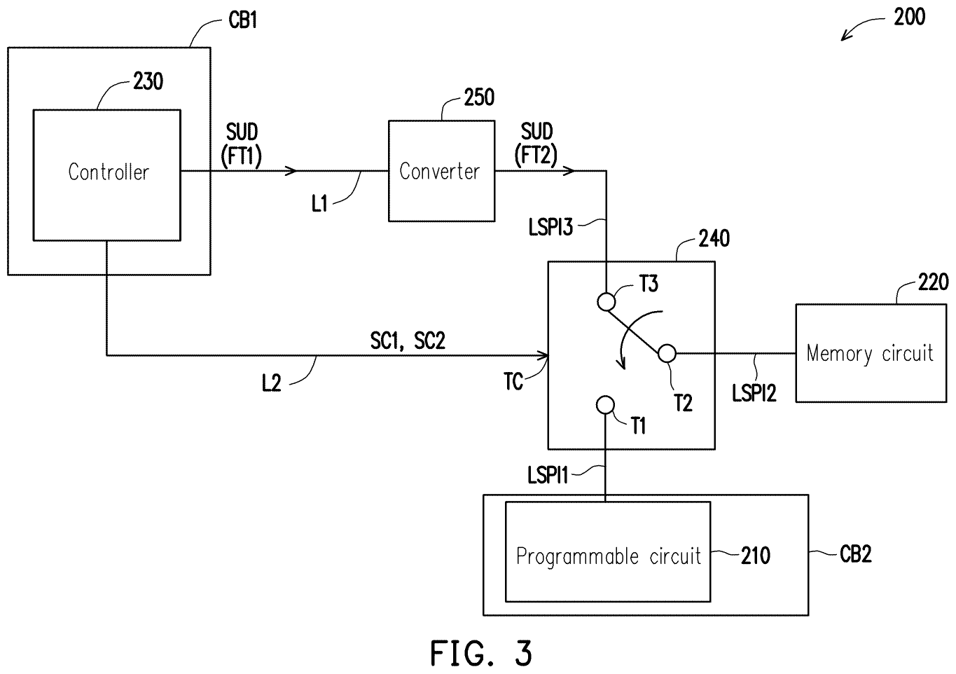

Referring to FIG. 3, FIG. 3 is a schematic diagram of an electronic system according to an embodiment of the disclosure. In the embodiment, an electronic system 200 includes a programmable circuit 210, a memory circuit 220, a controller 230, a switching circuit 240, and a converter 250. For example, the electronic system 200 may be a server rack including a plurality of servers or a facility including server racks, but the disclosure is not limited thereto. For example, the programmable circuit 210 may be, for example, a field programmable gate array (FPGA) or may be used to perform boot settings of at least one server in the server rack, but the disclosure is not limited thereto.

In the embodiment, the switching circuit 240 includes the first terminal T1, the second terminal T2, the third terminal T3, and the control terminal TC. The first terminal T1 is coupled to the programmable circuit 210. The second terminal T2 is coupled to the memory circuit 220. The control terminal TC is coupled to the controller 230. The converter 250 is coupled to the controller 230 and the third terminal T3. Furthermore, the converter 250 is coupled to the controller 230 through a first communication protocol FT1 and coupled to the third terminal T3 through a second communication protocol FT2. The converter 250 converts interfaces of two different communication protocols. The controller 230 provides the update data SUD to the third terminal T3 through the converter 250. The converter 250 receives the update data SUD provided by the controller 230 through the first communication protocol FT1, and then provides the same to the third terminal T3 of the switching circuit 240 through the second communication protocol FT2. The first communication protocol FT1 is, for example, an inter-integrated circuit (I2C) interface. The second communication protocol FT2 is, for example, a serial peripheral interface bus (SPI).

The controller 230 provides the first control signal SC1. The control terminal TC of the switching circuit 240 receives the first control signal SC1. The switching circuit 240 connects the third terminal T3 to the second terminal T2 based on the first control signal SC1. Therefore, the update data SUD received by the switching circuit 240 is recorded into the memory circuit 220.

In the embodiment, the controller 230 may further provide the second control signal SC2. The control terminal TC of the switching circuit 240 receives the second control signal SC2. The switching circuit 240 connects the second terminal T2 to the first terminal T1 based on the second control signal SC2. Therefore, the programmable circuit 210 is connected to the memory circuit 220 through the switching circuit 240. Therefore, the update data SUD stored in the memory circuit 220 is loaded into the programmable circuit 210.

In the embodiment, the controller 230 is disposed on a first circuit board CB1. The programmable circuit 210 is disposed on a second circuit board CB2. The controller 230 may be allowed to perform an update operation on the programmable circuit 210 over long distances. Therefore, the controller 230 may, for example, transmit the update data SUD to the remotely located converter 250 through a bus L1 that complies with the I2C interface. In addition, the controller 230 may be, for example, connected to the control terminal TC of the switching circuit 240 through a connection line L2 that complies with a general-purpose input/output (GPIO) communication protocol. Therefore, the controller 230 may, for example, control the switching operation of the remotely located switching circuit 240 through the connection line L2. For example, the first circuit board CB1 with the controller 230 may be disposed at a first place. The second circuit board CB2 with the programmable circuit 210, the memory circuit 220, the switching circuit 240, and the converter 250 may be disposed in a facility at a second place. The distance between the first place and the second place is more than 1 meter. Therefore, the controller 230 performs a remote update operation on the programmable circuit 210.

In the embodiment, the first terminal T1 may be, for example, connected to the programmable circuit 210 through a serial peripheral interface bus LSPI1. The second terminal T2 may be, for example, connected to the memory circuit 220 through a SPI bus LSPI2. The converter 250 may be, for example, connected to the third terminal T3 through a SPI bus LSPI3, but the disclosure is not limited to the above connection method of the switching circuit 240.

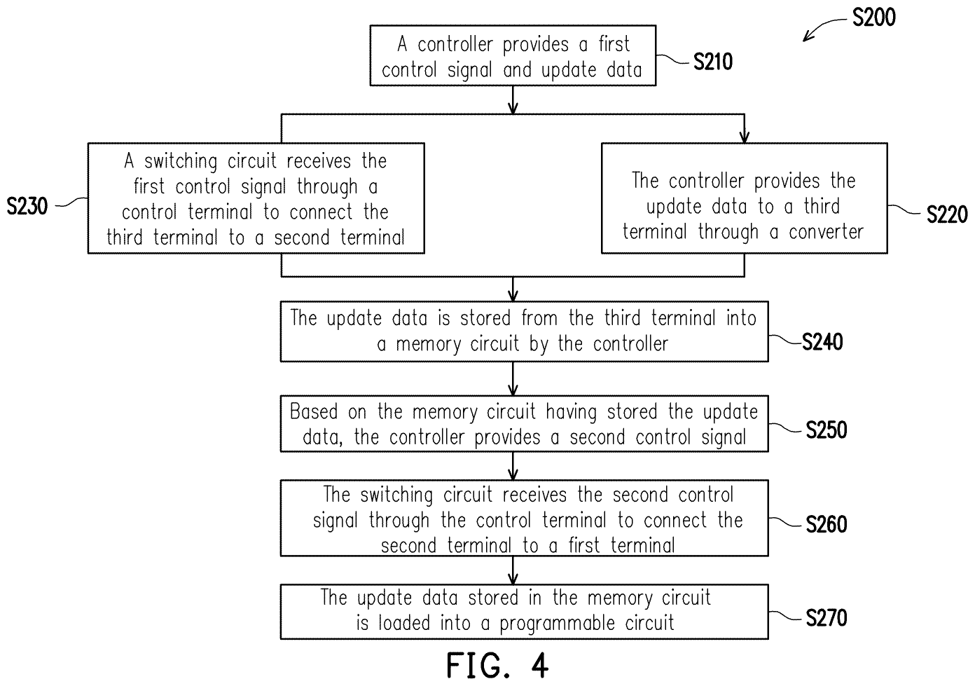

Referring to FIG. 3 and FIG. 4 at the same time, FIG. 4 is a flowchart of an operating method according to an embodiment of the disclosure. In the embodiment, an operating method S200 is applicable to the electronic system 200. The operating method S200 includes steps S210 to S270. In step S210, the controller 230 provides the first control signal SC1. In step S220, the controller 230 provides the update data SUD to the third terminal T3 through the converter 250. In step S230, the switching circuit 240 receives the first control signal SC1 through the control terminal TC to connect the third terminal T3 to the second terminal T2. In the embodiment, steps S220 and S230 may be performed at the same time. In some embodiments, step S220 precedes step S230. In some embodiments, step S220 is later than step S230.

In step S240, the update data SUD is stored from the third terminal T3 into the memory circuit 220 by the controller 230. In step S250, based on the memory circuit 220 having stored the update data, the controller 230 provides the second control signal SC2. In step S260, the switching circuit 240 receives the second control signal SC2 through the control terminal TC to connect the second terminal T2 to the first terminal T1. In step S270, the update data SUD stored in the memory circuit 220 is loaded into the programmable circuit 210.

In summary, the switching circuit receives the update data and writes the update data to the memory circuit. The disclosure does not require the controller to perform an update to the FPGA using the transmission method specified by the JTAG. Therefore, the update operation of the disclosure does not have limitations on transmission distance.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An electronic system, comprising:
a programmable circuit;
a memory circuit;
a controller, adapted to provide a first control signal; and
a switching circuit, having a control terminal, a first terminal, a second terminal, and a third terminal, wherein the first terminal is coupled to the programmable circuit, the second terminal is coupled to the memory circuit, and the control terminal and the third terminal are coupled to the controller;
wherein the switching circuit is adapted to receive the first control signal through the control terminal to connect the third terminal to the second terminal, so as to store update data into the memory circuit.

2. The electronic system according to claim 1, wherein the controller also provides the update data, and when the switching circuit receives the first control signal through the control terminal, the update data is stored into the memory circuit through the second terminal and the third terminal.

3. The electronic system according to claim 1,
wherein the controller provides a second control signal based on the memory circuit having stored the update data, and
the switching circuit is adapted to receive the second control signal through the control terminal to connect the second terminal to the first terminal, so that the update data stored in the memory circuit is adapted to be loaded into the programmable circuit.

4. The electronic system according to claim 1, wherein the programmable circuit comprises a field programmable gate array (FPGA).

5. The electronic system according to claim 1, wherein the controller comprises a general-purpose input/output (GPIO) pin, and the controller is coupled to the control terminal of the switching circuit through the GPIO pin.

6. The electronic system according to claim 1, wherein the controller is disposed on a first circuit board, and the programmable circuit is disposed on a second circuit board.

7. The electronic system according to claim 1, further comprising:
a converter, coupled to the controller through a first communication protocol, and coupled to the third terminal through a second communication protocol, wherein the controller provides the update data to the third terminal through the converter.

8. The electronic system according to claim 7, wherein the first communication protocol comprises an inter-integrated circuit (I2C) interface, and the second communication protocol comprises a serial peripheral interface bus (SPI).

9. An operating method for an electronic system, wherein the electronic system comprises a programmable circuit, a memory circuit, a switching circuit, and a controller, the switching circuit has a control terminal, a first terminal, a second terminal, and a third terminal, the first terminal is coupled to the programmable circuit, the second terminal is coupled to the memory circuit, and the control terminal and the third terminal are coupled to the controller, the operating method comprising:
providing a first control signal by the controller;
receiving the first control signal through the control terminal to connect the third terminal to the second terminal by the switching circuit; and
storing update data from the third terminal into the memory circuit by the controller.

10. The operating method according to claim 9, further comprising an update operation step, the update operation step comprising:
based on the memory circuit having stored the update data, providing a second control signal by the controller; and
receiving the second control signal through the control terminal to connect the second terminal to the first terminal by the switching circuit, so that the update data stored in the memory circuit is adapted for loading into the programmable circuit.

11. The operating method according to claim 9, wherein the electronic system further comprises a converter, and the converter is coupled to the controller through a first communication protocol and coupled to the third terminal through a second communication protocol, the operating method also comprising:
providing the update data to the third terminal through the converter by the controller.
